(19) United States
(12) Patent Application Publication
(10) Pub. No.: US 2012/0084795 A1
(43) Pub. Date: Apr. 5, 2012

(54) MODEL, SERVICE AND IMPLEMENTATION SEPARATION

(75) Inventors: Scott A. Konersmann, Monroe, WA (US); Edward W. Dudenhoefer, Kirkland, WA (US); Samer Boshra, Woodinville, WA (US); Maciej Sarnowicz, Redmond, WA (US)

(73) Assignee: MICROSOFT CORPORATION, Redmond, WA (US)

(21) Appl. No.: 12/895,511

(22) Filed: Sep. 30, 2010

(51) Int. Cl. G06F 9/46; G06F 9/44

(52) U.S. Cl. 719/316

(57) ABSTRACT

Embodiments are directed to combining service operations with various managed system objects to form a new dynamic programming interface combination and determining valid dynamic programming interface combinations. A computer system determines which service operations are offered by a selected managed system. The selected managed system is configured to provide various services comprising multiple different service operations. The computer system determines that managed system objects of the managed system are to be combined with at least one of the service operations. The computer system also combines the service operation with the managed system object, so that a new dynamic programming interface combination is created. The new dynamic programming interface combination is configured for use by the services offered by the managed system.

### BACKGROUND

Computers have become highly integrated in the workforce, in the home, in mobile devices, and many other places. Computers can process massive amounts of information quickly and efficiently. Software applications designed to run on computer systems allow users to perform a wide variety of functions including business applications, schoolwork, entertainment and more. Software applications are often designed to perform specific tasks, such as word processor applications for drafting documents, or email programs for sending, receiving and organizing email.

In many cases, software applications are designed to interact with other software applications or other computer systems. For example, client computer systems may be configured to request and receive services or software applications hosted by a back-end server. In some cases, the back-end server's services may have various different service operations. These service operations are typically tied to model objects and will only work with those specific model objects.

### BRIEF SUMMARY

Embodiments described herein are directed to combining service operations with various managed system objects to form a new dynamic programming interface combination and determining valid dynamic programming interface combinations. In one embodiment, a computer system determines which service operations are offered by a selected managed system. The selected managed system is configured to provide various services comprising multiple different service operations. The computer system determines that managed system objects of the managed system are to be combined with at least one of the service operations. The computer system also combines the service operation with the managed system object, so that a new dynamic programming interface combination is created. The new dynamic programming interface combination is configured for use by the services offered by the managed system.

In another embodiment, a computer system implements a provider component on a selected managed system. The provider component provides functionality including various dynamic programming interface combinations that combine service operations with managed system objects. The computer system determines which dynamic programming interface combinations are valid for the selected managed system based on which dynamic programming interface combinations are offered by the provider component. The computer system also receives a user (or programmatic) input indicating that at least one of the valid dynamic programming interface combinations is to be processed according to user-provided properties.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

To further clarify the above and other advantages and features of embodiments of the present invention, a more particular description of embodiments of the present invention will be rendered by reference to the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a computer architecture in which embodiments of the present invention may operate including combining service operations with various managed system objects to form a new dynamic programming interface combination and determining valid dynamic programming interface combinations.

FIG. 2 illustrates a flowchart of an example method for combining service operations with various managed system objects to form a new dynamic programming interface combination.

FIG. 3 illustrates a flowchart of an example method for determining valid dynamic programming interface combinations.

FIG. 4 illustrates an embodiment of the present invention in which application model, service and implementation are separated.

### DETAILED DESCRIPTION

Embodiments described herein are directed to combining service operations with various managed system objects to form a new dynamic programming interface combination and determining valid dynamic programming interface combinations. In one embodiment, a computer system determines which service operations are offered by a selected managed system. The selected managed system is configured to provide various services comprising multiple different service operations. The computer system determines that managed system objects of the managed system are to be combined with at least one of the service operations. The computer system also combines the service operation with the managed system object, so that a new dynamic programming interface combination is created. The new dynamic programming interface combination is configured for use by the services offered by the managed system.

In another embodiment, a computer system implements a provider component on a selected managed system. The provider component provides functionality including various dynamic programming interface combinations that combine service operations with managed system objects. The computer system determines which dynamic programming interface combinations are valid for the selected managed system based on which dynamic programming interface combinations are offered by the provider component. The computer system also receives a user input indicating that at least one of the valid dynamic programming interface combinations is to be processed according to user-provided properties.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

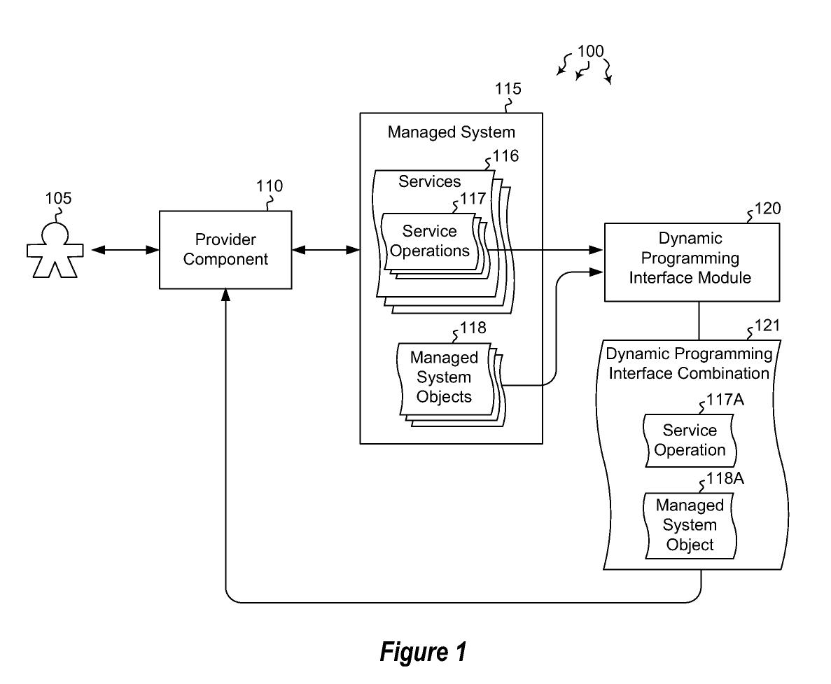

FIG. 1 illustrates a computer architecture 100 in which the principles of the present invention may be employed. Computer architecture 100 includes managed system 115. In some cases, managed system 115 may be a computer server such as a web server, back-end server, service provider, or a collection of such servers (i.e. distributed or cloud-based servers). The managed system may include services 116 which themselves include service operations 117. Services, as used herein, may include any type of software functionality including applications, functions, web services or the like. Services may also include hardware devices (or access thereto) or other means of providing functionality to a user. Service operations include portions of services or actions such as create, delete or script. Service operations may include a single action or a combination of actions to perform a given operation. Thus, for example, if a service provides online banking, multiple different service operations (including login authentication, database accessing, etc.) operate to provide the service's functionality.

The services may interact with or otherwise use managed system objects 118. Managed system objects include any data files, databases (including individual rows, columns or cells), user objects or any other portion of data used or stored by the managed system. In some cases, services 116 implement managed system objects 118 in providing the service. In some embodiments, services or service operations are specifically designed to work with certain managed system objects, and use specialized protocols or interface methods when implementing the service operation/managed system object combination. Accordingly, dynamic programming interface combining module 120 may be configured to combine a given service operation 117A with a given managed system object 118A into dynamic programming interface combination 121. This dynamic programming interface combination 121 may be provided to provider component 110, which interfaces with the user 105. In this manner, the provider component can provide access to any service operation/managed system object combination that the managed system is capable of providing.

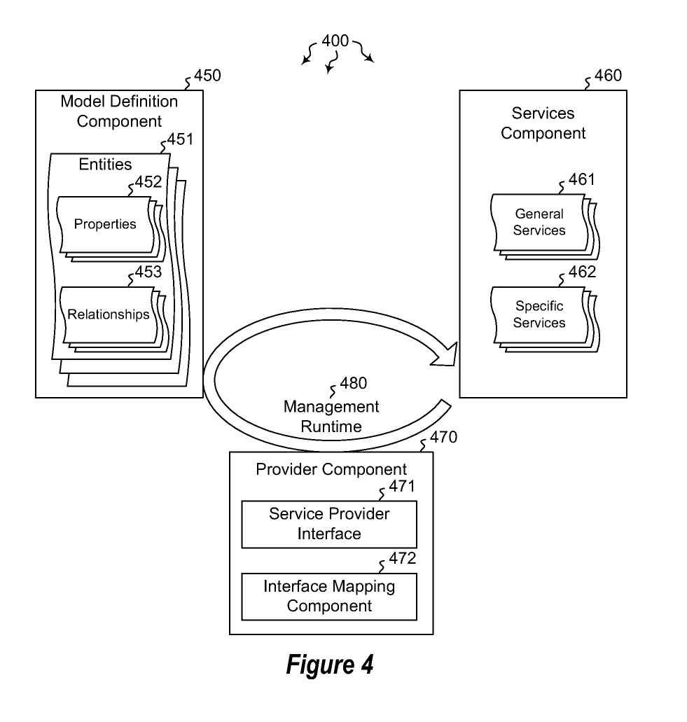

As shown in FIG. 4, the model of a system (the managed system objects (a.k.a. entities 451) along with the object's corresponding properties 452 and relationships 453), the services of the model (e.g. general services 461 and specific services 462) and the implementation of the target managed system (e.g. provider component 470) may be separated. This separation provides the ability to dynamically change the model (i.e. the entities, properties and relationships) without affecting the services that can operate against the model. It also allows a single model to be implemented by multiple back-end systems (e.g. boxed products and software as a service), even if there are semantic differences between the back-end systems. This separation ensures that a change to one back-end server doesn't affect any other back end. Moreover, each of these features insulates the calling tools from having to understand the differences between the various back-end systems.

This invention clears and separates the roles of components within manageability stack into a few distinct areas: Metadata—encoding of the management domain types, properties, and relationships, Services—generic services that work against any domain which provide an algorithm or other value against the runtime. Examples are Navigation, Serialization, Query, CRUD (create, read, update and delete), Provider—plug in component that that provides implementation of a whole or part of a service related to a back end system that is the target of the management. There is one provider implementation per back-end system type (SQL Server, Analysis Services Server, etc) Management Runtime—provides interface for manipulating and querying the domain and instance data as well as local storage for the instance data that is used by the runtime.

In one embodiment, a manageability service is added that provides backup functionality. An existing system (e.g. a structured query language (SQL) server) may define backup semantics for initiating the corresponding service operation 117, as well as server, database, table and file managed system objects. In this embodiment, the implementation of the provider for SQL Server Database Engine allows the backup service semantics to be combined with database and file system objects, making the backup service available for the database and file system objects. In other embodiments, a provider component (e.g. 110) may allow specific service operation/managed system object combinations, while disallowing others.

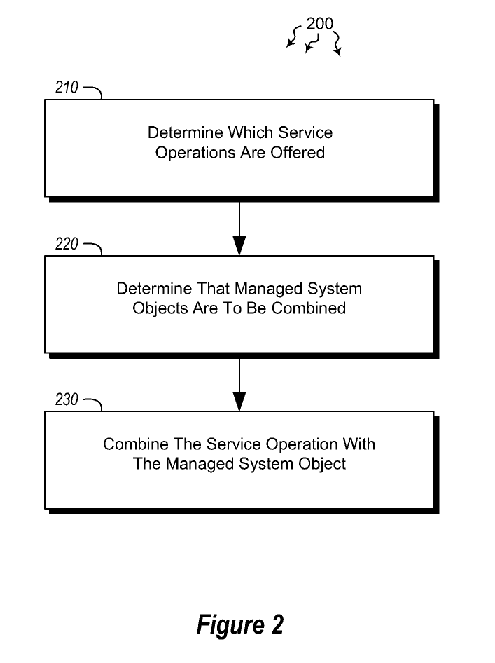

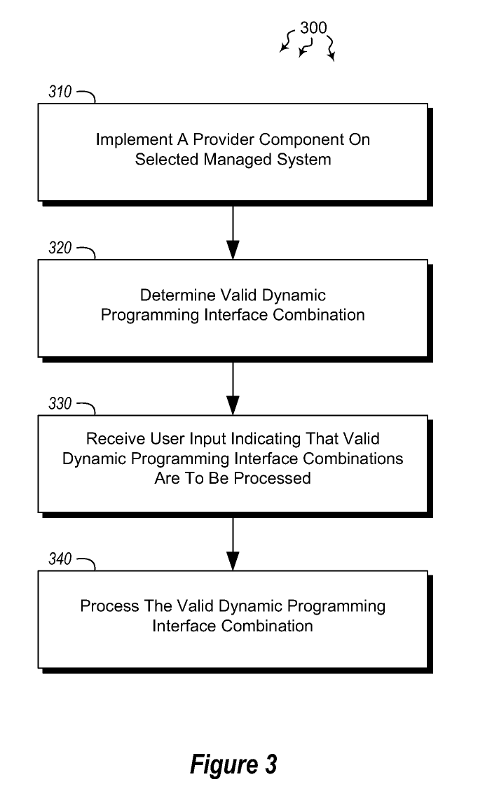

From the user's perspective, the use of a given service (e.g. a backup service) is not substantially changed, as the service itself is not changed. The context in which the service is available (i.e. the managed system objects for which the service is available) may be determined dynamically at runtime. Logic specific to the back-end system (i.e. managed system 115) may be encapsulated into the provider component and used when a specific provider is instantiated based on the back-end system connection. Additionally, developers may be able to implement and test a new provider without changing existing providers and without risking introducing new defects in already implemented sections of the code. These and other concepts will be explained in greater detail below with regard to methods 200 and 300 of FIGS. 2 and 3.

In view of the systems and architectures described above, methodologies that may be implemented in accordance with the disclosed subject matter will be better appreciated with reference to the flow charts of FIGS. 2 and 3. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 2 illustrates a flowchart of a method 200 for combining service operations with various managed system objects to form a new dynamic programming interface combination. The method 200 will now be described with frequent reference to the components and data of environment 100.

Method 200 includes an act of determining which service operations are offered by a selected managed system, wherein the selected managed system is configured to provide one or more services comprising a plurality of different service operations (act 210). For example, managed system 115 may offer various different service operations 117 which are part of service 116. The services may provide various different types of functionality for users 105. In some cases, users log in or otherwise authenticate to managed system 115 to gain access to the provided services. The user may query the managed system to determine its software version and software capabilities. The managed system may reply directly to the query, or may include the version information in other data that is sent to the client (e.g. through provider component 110).

As shown in FIG. 4, a separate services component 460 may be available to the management runtime 480. The services component may include general services 461 and specific services 462. Non-limiting examples of general services may include, but are not limited to, navigation, metadata, CRUD, query, scripting, serialization, difference operations and other services. Non-limiting examples of specific services may include, but are not limited to, backup services, policy evaluation services and others. As further shown in FIG. 4, a separate model definition component 450 may be available to the management runtime. The model definition component describes a model which includes various entities (i.e. managed system objects) which each have associated properties 452 and relationships 453. The model and services of components 450 and 460 may be available to provider component 470, which is configured to provide the features of the model and service (i.e. dynamic programming interface combination 121) via service provider interface 471, to which the interface mapping component 472 has mapped the combined functionality of the dynamic programming interface combination.

Method 200 includes an act of determining that one or more managed system objects of the managed system are to be combined with at least one of the service operations (act 220). For example, user 105 may indicate a desire to use a certain managed system object with a certain service or service operation. Accordingly, in such cases, managed system 115 may determine that specific system objects 118 and specific service operations 117 are to be combined. Within managed system 115, managed system objects (also referred to herein as entities) including their corresponding properties and relationships to other system objects and service operations 117 may be defined separately. As such, the service operations can work with multiple different managed system objects. Service operations that have specific (version-specific or edition-specific) semantics can be combined with system objects and provided to a user via a provider module.

Thus, the provider module allows virtually any service operation to be used with virtually any managed object or entity, regardless of specific semantics or other specific requirements for using an object or service. Here, it will be understood that a provider is not required to allow all services to be used against all models. Rather, mappings may be partial and client applications may be altered to inquire whether a given operation or model is available. Furthermore, client applications may be altered to show or hide user interface options base on whether those options exist for a given back-end version.

Method 200 includes an act of combining the service operation with the managed system object, such that a new dynamic programming interface combination is created, wherein the new dynamic programming interface combination is configured for use by the one or more services offered by the managed system (act 230). For example, dynamic programming interface combining module 120 may combine a service operation 117 with a managed system object 118 to create dynamic programming interface combination 121. Provider component 110 may be implemented to provide the service functionality to the user, in combination with certain managed system objects. For instance, if service operation 117A was a “delete” operation and managed system object 118A was a “file” object, provider component 110 would provide a “delete file” dynamic programming interface combination to the user. It will be understood by one skilled in the art that this is only one example of service operations and system objects which may be implemented by provider 110, and that substantially any combination of service operations and system objects may be used.

In some cases, the provider indicates which dynamic programming interface combinations the managed system supports. For dynamic programming interface combinations supported by the managed system, the provider may map the dynamic programming interface combination to a user interface for selection by a user. Accordingly, in such cases, a user may be able to use the service operation and managed system objects provided through the provider module by accessing a user interface. The user interface will only present those options that are available for the version or edition of the back-end system to which the user is connected. Thus, features not provided by a certain software version or edition are not displayed in the user interface.

User 105 may be able to provide various different properties that are to be used in conjunction with the user-selected dynamic programming interface combination (e.g. 121). The provider component may perform the selected dynamic programming interface combination and map the result to the managed system where the result is accessible by the user. The properties provided by the user may be used in the execution of the dynamic programming interface combination. In some cases, various portions of managed-system-specific logic are delegated to the provider component. The provider component can then provide services to the user using the delegated logic.

In some embodiments, support can be added for a new managed system without affecting the other managed systems using a provider specific to the new managed system. In other words, if a given managed system is already in use, a new managed system can be added and implemented by adding a new provider component. Thus, in such cases, each back-end server will have its own provider, which provides those service operations and managed system objects that are offered by that version or edition of back-end server. As each provider provides only those services and system objects that are made available by the provider's corresponding back-end server, each provider is custom-tailored to its back-end server. In this manner, a provider specific to a given managed system can change a managed system implementation without affecting the other managed systems.

Turning now to FIG. 3, FIG. 3 illustrates a flowchart of a method 300 for determining valid dynamic programming interface combinations. The method 300 will now be described with frequent reference to the components and data of environments 100 of FIGS. 1 and 400 of FIG. 4.

Method 300 includes an act of implementing a provider component on a selected managed system, wherein the provider component provides various functionality including one or more dynamic programming interface combinations that combine service operations with managed system objects (act 310). For example, provider component 470 may be implemented on management runtime 480 of a managed system (e.g. 115). The provider component provides functionality including, at least in some cases, a service provider interface 471, an interface mapping component 472 and one or more dynamic programming interface combinations 121 that combine service operations 117 with managed system objects 118. As indicated above, the managed system objects are defined separately from the service operations which are provided by the managed system. As such, the service operations may be configured to work with a plurality of different managed system objects, regardless of what back-end server edition or version is being used.

Method 300 includes an act of determining which dynamic programming interface combinations are valid for the selected managed system based on which dynamic programming interface combinations are offered by the provider component (act 320). For example, it may be determined which dynamic programming interface combinations 121 are valid for a specific version or edition of a managed system 115 based on which dynamic programming interface combinations are offered by the provider component 110. The provider component may be configured to provide to the service provider interface 471 only those service operations and managed system objects that the managed system is capable of providing.

Method 300 also includes an act of receiving a user input indicating that at least one of the valid dynamic programming interface combinations is to be processed according to one or more user-provided properties (act 330). For example, user 105 may provide an input stating that dynamic programming interface combination 121 is to be processed according to one or more user provided settings or properties. For instance, a user may have a rule or policy which the user wants implemented during the processing of the dynamic programming interface combination. The provider component may implement the policy as part of providing the services of its corresponding managed system.

By implementing a detached provider component that interfaces with the other components (i.e. the model definition component and the services component) via the management runtime, a managed system implementation may be changed without affecting the other managed systems. When a new (or different) managed system is used, a new provider may be implemented which provides those services and managed system objects of the new or different managed system. This separation of managed objects, services and implementation via the provider allows back-end systems to be changed or upgraded without affecting any other managed systems in the network. Moreover, this separation allows dynamic programming interfaces to be managed regardless of how the dynamic programming interface was created, and no assumptions have to be made about what is included in the interface. The provider component associated with each managed system indicates what is provided by that system.

Method 300 includes an act of processing the indicated valid dynamic programming interface combinations according to the user-provided properties (act 340). For example, a valid dynamic programming interface combination 121 may be processed using the user-provided properties. Thus, a user may dictate that an dynamic programming interface combination be processed according to a given rule or policy.

Accordingly, systems, methods and computer program products are provided which combine service operations with various managed system objects to form new dynamic programming interface combinations. Moreover, systems, methods and computer program products are provided which determine valid dynamic programming interface combinations for a given managed system. The valid dynamic programming interface combinations are implemented via a provider component which is specific to each managed system.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. At a computer system including a processor and a memory, in a computer networking environment including a plurality of computing systems, a computer-implemented method for combining service operations with various managed system objects to form a new dynamic programming interface combination, the method comprising:
an act of determining which service operations are offered by a selected managed system, wherein the selected managed system is configured to provide one or more services comprising a plurality of different service operations;
an act of determining that one or more managed system objects of the managed system are to be combined with at least one of the service operations; and
an act of combining the service operation with the managed system object, such that a new dynamic programming interface combination is created, wherein the new dynamic programming interface combination is configured for use by the one or more services offered by the managed system.

2. The method of claim 1, wherein the managed system objects are defined separately from the service operations which are provided by the managed system.

3. The method of claim 2, wherein the service operations are configured to work with a plurality of different managed system objects.

4. The method of claim 1, further comprising an act of implementing a provider component on the selected managed system.

5. The method of claim 4, wherein the provider indicates which dynamic programming interface combinations the selected managed system supports.

6. The method of claim 5, wherein for dynamic programming interface combinations supported by the selected managed system, the provider maps the dynamic programming interface combination to a user interface for selection by a user.

7. The method of claim 6, wherein the user provides one or more properties that are to be used in conjunction with the user-selected dynamic programming interface combination.

8. The method of claim 6, wherein the provider performs the selected dynamic programming interface combination and maps the result to the managed system where the result is accessible by the user.

9. The method of claim 4, wherein one or more portions of managed-system-specific logic are delegated to the provider component.

10. The method of claim 4, further comprising an act of adding support for a new managed system without affecting the other managed systems using a provider specific to the new managed system.

11. The method of claim 4, further comprising an act of changing a managed system implementation without affecting the other managed systems using a provider specific to the changed managed system.

12. The method of claim 1, further comprising an act of querying the managed system to determine its software version and software capabilities.

13. The method of claim 1, wherein the user indicates which type of managed system the user is attempting to connect to.

14. A computer program product for implementing a method for determining valid dynamic programming interface combinations, the computer program product comprising one or more computer-readable storage media having stored thereon computer-executable instructions that, when executed by one or more processors of the computing system, cause the computing system to perform the method, the method comprising:
an act of implementing a provider component on a selected managed system, wherein the provider component provides various functionality including one or more dynamic programming interface combinations that combine service operations with managed system objects;
an act of determining which dynamic programming interface combinations are valid for the selected managed system based on which dynamic programming interface combinations are offered by the provider component;
an act of receiving a user input indicating that at least one of the valid dynamic programming interface combinations is to be processed according to one or more user-provided properties; and
an act of processing the indicated valid dynamic programming interface combinations according to the user-provided properties.

15. The computer program product of claim 14, further comprising an act of implementing a provider component on the selected managed system.

16. The computer program product of claim 15, further comprising an act of changing a managed system implementation without affecting the other managed systems using a provider specific to the changed managed system.

17. The computer program product of claim 15, wherein one or more portions of managed-system-specific logic are delegated to the provider component.

18. The computer program product of claim 14, wherein the managed system objects are defined separately from the service operations which are provided by the managed system.

19. The computer program product of claim 14, wherein dynamic programming interfaces are managed regardless of how the interface was created, wherein no assumptions are made about what is included in the interface.

20. A computer system comprising the following:
one or more processors;
system memory;
one or more computer-readable storage media having stored thereon computer-executable instructions that, when executed by the one or more processors, causes the computing system to perform a method for combining service operations with various managed system objects to form a new dynamic programming interface combination, the method comprising the following:
an act of determining which service operations are offered by a selected managed system, wherein the selected managed system is configured to provide one or more services comprising a plurality of different service operations;
an act of determining that one or more managed system objects of the managed system are to be combined with at least one of the service operations;
an act of combining the service operation with the managed system object, such that a new dynamic programming interface combination is created, wherein the new dynamic programming interface combination is configured for use by the one or more services offered by the managed system;
an act of implementing a provider component on the selected managed system; and
an act of changing a managed system implementation without affecting the other managed systems using a provider specific to the changed managed system.
